(19) United States
(12) Patent Application Publication
(10) Pub. No.: US 2020/0316575 A1
(43) Pub. Date: Oct. 8, 2020

(54) Olefin Polymerization Catalyst Component Having Carbonate Compounds

(71) Applicant: Formosa Plastics Corporation, USA, Livingston, NJ (US)

(72) Inventors: Gapgoung Kong, Sugarland, TX (US); Lei Zhang, Port Lavaca, TX (US); Chih-Jian Chen, Port Lavaca, TX (US); Demin Xu, Port Lavaca, TX (US); Guangxue Xu, Port Lavaca, TX (US)

(21) Appl. No.: 16/375,346

(22) Filed: Apr. 4, 2019

(51) Int. Cl. B01J 31/02; C08F 4/659; C08F 210/16; C08F 4/02; C08F 297/08; C08F 4/649

(52) U.S. Cl. CPC B01J 31/0209; C08F 4/65912; C08F 210/16; C08F 4/022; C08F 297/083; C08F 2500/15; B01J 2231/122; B01J 2531/004; B01J 2531/46; B01J 2531/0213; C08F 4/6494

(57) ABSTRACT

The present invention relates to Ziegler-Natta catalyst components for olefin polymerization employing specific carbonate compounds as an element of solid catalyst composition in conjunction with at least one or more internal donor compounds, for producing polyolefins, particularly polypropylene and ethylene-propylene block co-polymer, which exhibits substantially high rubber content with higher stereo-regularity and hydrogen response.

### BACKGROUND

This invention relates to Ziegler-Natta catalyst components for olefin polymerization employing specific carbonate compounds as an element of a solid catalyst composition in conjunction with at least one or more internal donor compounds. The present invention further relates to methods of making such polymerization catalyst systems, and to polymerization processes for producing polyolefins, particularly polypropylene and ethylene-propylene block co-polymer, which provide high rubber content with higher stereo-regularity and activity.

Ziegler-Natta catalyst systems for polyolefin polymerization are well known in the art. Commonly, these systems are composed of a solid Ziegler-Natta catalyst component and a co-catalyst component, usually an organoaluminum compound, and/or an external electron donor to be used in conjunction. The Ziegler-Natta catalyst components generally include magnesium, halide, titanium and internal electron donor compounds which have been widely employed to increase the activity and stereo-specificity of polymerization catalyst system.

Common internal electron donor compounds, which are incorporated in the solid Ziegler-Natta catalyst component during preparation of such component, are known in the art and include ethers, ketones, amines, alcohols, heterocyclic organic compounds, phenols, phosphines, and silanes. It is well known in the art that polymerization activity, as well as stereoregularity, molecular weight, and molecular weight distribution of the resulting polymer depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 5,948,872; 6,048,818; 6,121,483; 6,281,301; 6,294,497; 6,313,238; 6,395,670; 6,436,864, 6,605,562; 6,716,939; 6,770,586; 6,818,583; 6,825,309; 7,022,640; 7,049,377; 7,202,314; 7,208,435; 7,223,712; 7,351,778; 7,371,802; 7,491,781; 7,544,748; 7,674,741; 7,674,943; 7,888,437; 7,888,438; 7,935,766; 7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,288,606; 8,318,626; 8,383,540; 8,536,290 8,569,195; 8,575,283; 8,604,146; 8,633,126; 8,692,927; 8,664,142; 8,680,222; 8,716,514; and 8,742,040, which are incorporated by reference herein.

In the utilization of Ziegler-Natta type catalysts for polymerizations involving propylene or other olefins for which isotacticity is a possibility, it may be desirable to utilize an external electron donor, and acceptable external electron donors include organic compounds containing O, Si, N, S, and/or P. Such compounds include organic acids, organic acid esters, organic acid anhydrides, ethers, ketones, alcohols, aldehydes, silanes, amides, carbonate, amines, amine oxides, thiols, various phosphorus acid esters and amides, etc. Preferred external electron donors are organosilicon compounds containing Si—O—C and/or Si—N—C bonds, having silicon as the central atom. Such compounds are described in U.S. Pat. Nos. 4,472,524; 4,473,660; 4,560,671; 4,581,342; 4,657,882; 5,106,807; 5,407,883; 5,684,173; 6,228,961; 6,362,124; 6,552,136; 6,689,849; 7,009,015; 7,244,794; 7,276,463; 7,619,049; 7,790,819; 8,247,504; 8,648,001; and 8,614,162, which are incorporated by reference herein. U.S. Pat. No. 6,271,310 lists carbonate as one potential external donor that may be used for propylene polymerization.

Most commercial propylene polymerization catalysts currently employ alkyl phthalate esters as an internal electron donor. But still there is a need to further improve stereo-regularity of catalyst components employing alkyl phthalate esters as an internal donor for the application of polypropylene polymer to impact copolymer area. Moreover, certain environmental issues have been recently raised concerning the continued use of phthalate derivatives in human contact applications. As a result, the employment of a phthalate-free propylene polymerization catalyst or a catalyst system that employs a reduced amount of phthalate is now necessary for the production of polypropylene to remedy these issues.

U.S. Pat. No. 6,323,150 describes the use of a propylene polymerization catalyst which contains a reduced amount of phthalate as an internal electron donor. However, the resulted polypropylene product was found to exhibit low isotacticity and productivity. This prior art reference also teaches a polymerization catalyst consisting of a polyether compound combined with the phthalate derivative as an internal electron donor. The resultant polypropylene product exhibits lower isotacticity than that of a catalyst containing only the phthalate derivative.

U.S. Pat. No. 7,491,781 teaches the use of an internal electron donor in a propylene polymerization catalyst component which does not contain a phthalate derivative. However, the resultant propylene polymerization catalyst produced polypropylene with lower isotacticity than that of a catalyst containing a phthalate derivative.

Recently, there has been a need for catalyst systems that can control multiple properties such as hydrogen response, isotacticity, molecular weight distribution and ethylene-propylene co-polymerization activity. Two or more internal electron donors, rather than single electron donor, have been employed in the solid catalyst composition to fulfill the multiple properties required. For example, U.S. Pat. No. 6,395,670 describes catalyst compositions employing two internal donors such as alkyl carboxylic esters and 1,3-diether to have a synergy effect by combining two internal electron donors. U.S. Pat. No. 7,208,435 describes catalyst compositions containing multiple electron donor compounds selected from phthalic acid ester or malonates compounds to provide a catalyst component having higher hydrogen response and high stereo-regularity as well. U.S. Patent App. 2015/0191852 describes catalyst compositions comprising at least two electron donors selected from succinates and 1,3-diethers.

Also, U.S. Pat. Nos. 9,777,084 and 9,815,920 teach the use of oxalic acid amide compound or urea compounds as a modifier in the composition of solid catalyst components to improve stereo-regularity that enables the production of phthalate-free catalyst system with stereo-regularity that is equal to or better than phthalate catalyst systems.

Still, propylene co-polymerization capability of catalyst components employing various electron donor compounds is not sufficient enough to reach the requirement of propylene block co-polymer having high impact strength as well as high stiffness. Specially, catalysts employing 1,3-diether donor shows lower co-polymerization capability in propylene block co-polymerization and rubber content in resulting propylene block co-polymer has been insufficient.

As such, there is still a need and desire to develop a catalyst component providing improved co-polymerization capability for block co-polymer of polypropylene while having high stereo-selectivity and high hydrogen response as well.

### SUMMARY OF THE INVENTION

Disclosed herein is a method of preparing a Ziegler-Natta catalyst components producing polypropylene with enhanced isotacticity and hydrogen response and co-polymerization capability for propylene block co-polymer, where the catalyst components comprise magnesium, titanium, halide, at least one or more internal electron donors, and carbonate compounds selected from the compound represented by Formula I:

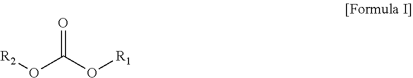

wherein R₁ and R_{2,} which may be identical or different, are independently selected from hydrogen, an aliphatic hydrocarbon group having 1 to 20 carbon atoms, an alicyclic hydrocarbon group having 3-20 carbon atoms, and an aromatic hydrocarbon group having 6-20 carbon atoms, wherein R₁ and R₂ may be linked to form one or more saturated or unsaturated monocyclic rings.

### DESCRIPTION OF PREFERRED EMBODIMENTS

In accordance with certain embodiments of the present invention, a class of carbonate compounds are disclosed, employing as an element of solid Ziegler-Natta catalyst components in conjunction with one or more internal donors, for the production of polyolefins, particularly polypropylene. The carbonate compounds of the present invention may be used in combination with one or more internal electron donors that are typically employed in Ziegler-Natta polypropylene catalyst systems such as 1,3-diethers, malonates, succinates, phthalic acid esters, esters of aliphatic or aromatic diols, or their derivatives.

According to certain aspects of the present invention, the carbonate compounds that may be employed as an element of solid catalyst composition in conjunction with internal donors for polymerization catalyst components are represented by Formula I:

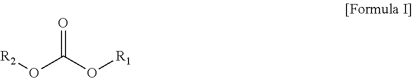

wherein R₁ and R_{2,} which may be identical or different, are independently selected from hydrogen, an aliphatic hydrocarbon group having 1 to 20 carbon atoms, an alicyclic hydrocarbon group having 3-20 carbon atoms, and an aromatic hydrocarbon group having 6-20 carbon atoms, wherein R₁ and R_{2,} may be linked to form one or more saturated or unsaturated monocyclic rings.

Preferred examples of suitable carbonate compounds of the Formula I include, but are not limited to: cyclic or non-cyclic dialkylcarbonates such as diethylcarbonate, dimethylcarbonate, diisopropylcarbonate, dipropylcarbonate, dibutylcarbonate, ditertbutylcarbonate, dicyclopentylcarbonate, dicyclohexylcarbonate, diphenylcarbonate, dibenzylcarbonate, propylene carbonate, ethylene carbonate, and trimethylene carbonate.

Typical, and acceptable, Ziegler-Natta type catalyst systems that may be used in accordance with the present invention comprise (a) a solid Ziegler-Natta type catalyst component containing carbonate compound in conjunction with internal donors, (b) a co-catalyst component, and optionally (c) one or more external electron donors. Preferred solid Ziegler-Natta type catalyst component (a) includes solid catalyst components comprising a titanium compound having at least a Ti-halogen bond and a carbonate compound in combination with an internal electron donor compound supported on an anhydrous magnesium-dihalide support.

The acceptable internal electron donor compounds for the preparation of solid Ziegler-Natta type catalyst component (a) are not generally limited and include, but are not limited to one or more internal electron donors that are typically employed in Ziegler-Natta polypropylene catalyst system, such as 1,3-diethers, malonates, succinates, phthalic acid esters, esters of aliphatic or aromatic diols, or their derivatives.

Examples of phthalic acid esters that can be used in conjunction with the carbonate compound of the present invention include, but are not limited to: diethylphthalate, di-n-propylphthalate, di-n-butylphthalate, di-n-pentylphthalate, di-i-pentylphthalate, bis(2-ethylhexyl)phthalate, ethylisobutylphthalate, ethyl-n-butylphthalate, di-n-hexylphthalate, and di-isobutylphthalate.

Examples of 1,3-diethers that can be used in conjunction with the carbonate compound of the present invention include, but are not limited to: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 1,1-bis(methoxymethyl)-7-(3,3,3-trifluoropropyl)indene, 1,1-bis(methoxymethyl)-7-trimethyisilylindene; 1,1-bis(methoxymethyl)-7-trifluoromethylindene, 1,1-bis(methoxymethyl)-4,7-dimethyl-4,5,6,7-tetrahydroindene, 1,1-bis(methoxymethyl)-7-methylindene, 1,1-bis(methoxymethyl)-1H-benz[e]indene, 1,1-bis(methoxymethyl)-1H-2-methylbenz[e]indene, 9,9-bis(methoxymethyl)fluorene, 9,9-bis(methoxymethyl)-2,3,6,7-tetramethylfluorene, 9,9-bis(methoxymethyl)-2,3,4,5,6,7-hexafluorofluorene, 9,9-bis(methoxymethyl)-2,3-benzofluorene, 9,9-bis(methoxymethyl)-2,3,6,7-dibenzofluorene, 9,9-bis(methoxymethyl)-2,7-diisopropylfluorene, 9,9-bis(methoxymethyl)-1,8-dichlorofluorene, 9,9-bis(methoxymethyl)-2,7-dicyclopentylfluorene, 9,9-bis(methoxymethyl)-1,8-difluorofluorene, 9,9-bis(methoxymethyl)-1,2,3,4-tetrahydrofluorene, 9,9-bis(methoxymethyl)-1,2,3,4,5,6,7,8-octahydrofluorene, and 9,9-bis(methoxymethyl)-4-tert-butylfluorene.

Examples of malonates that can be used in conjunction with the carbonate compound of the present invention include, but are not limited to: diethyl 2-isopropylmalonate, diethyl 2-phenylmalonate, dineopentyl 2-isopropylmalonate, diisobutyl 2-isopropylmalonate, di-n-butyl 2-isopropylmalonate, diethyl 2-dodecylmalonate, diethyl 2-t-butylmalonate, diethyl 2-(2-pentyl)malonate, diethyl 2-cyclohexylmalonate, dineopentyl 2-t-butylmalonate, dineopentyl 2-isobutylmalonate, diethyl 2-cyclohexylmethylmalonate, dimethyl 2-cyclohexylmethylmalonate, diethyl 2,2-dibenzylmalonate, diethyl 2-isobutyl-2-cyclohexylmalonate, dimethyl 2-n-butyl-2-isobutylmalonate, diethyl 2-n-butyl-2-isobutylmalonate, diethyl 2-isopropyl-2-n-butylmalonate, diethyl 2-methyl-2-isopropylmalonate, diethyl 2-isopropyl-2-isobutylmalonate, diethyl 2-methyl-2-isobutylmalonate, diethyl 2-isobutyl-2-benzylmalonate, and diethyldiisobutylmalonate.

Examples of succinates that can be used in conjunction with the carbonate compound of the present invention include, but are not limited to: diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmeth)succinate, diethyl sobutylsuccinate, diethyl 2,3-dineopentylsuccinate, diethyl 2,3-dicyclopentylsuccinate, diethyl 2,3-dicyclohexylsuccinate.

Examples of esters of aliphatic or aromatic diols that can be used in conjunction with the carbonate compound of the present invention include, but are not limited to: 1,3-propylene-glycol dibenzoate, 2-methyl-1,3-propylene-glycol dibenzoate, 2-ethyl-1,3-propylene-glycol dibenzoate, 2-propyl-1,3-propylene-glycol dibenzoate, 2-butyl-1,3-propylene-glycol dibenzoate, 2,2-dimethyl-1,3-propylene-glycol dibenzoate, (R)-1-phenyl-1,3-propylene-glycol dibenzoate, (S)-1-phenyl-1,3-propylene-glycol dibenzoate, 1,3 -diphenyl-1,3-propylene-glycol dibenzoate, 2-methyl-1,3-diphenyl-1,3-propylene-glycol dibenzoate, 1,3-diphenyl-1,3-propylene-glycol dipropionate, 2-methyl-1,3-diphenyl-1,3-propylene-glycol dipropionate, 2,4-pentanediol dibenzoate, 3-methyl-2,4-pentanediol dibenzoate, 3-ethyl-2,4-pentanediol dibenzoate, 3-propyl-2,4-pentanediol dibenzoate, 3-butyl-2,4-pentanediol dibenzoate, 3,3-dimethyl-2,4-pentanediol dibenzoate, (2S,4S)-(+)-2,4-pentanediol dibenzoate, (2R,4R)-(+)-2,4-pentanediol dibenzoate, 2,4-pentanediol di(p-chlorobenzoate), 2,4-pentanediol di(m-chlorobenzoate), 2,4-pentanediol di(p-bromobenzoate), 2,4-pentanediol di(o-bromobenzoate), 2,4-pentanediol di(p-methylbenzoate) 2,4-pentanediol di(p-tert-butylbenzoate), 2,4-pentanediol di(p-butylbenzoate), 2,4-pentanediol dicinnamate, 2-methyl-1,3-pentanediol dibenzoate, 2-methyl-1,3-pentanediol di(p-chlorobenzoate), 2-methyl-1,3-pentanediol di(p-methylbenzoate), 2-butyl-1,3-pentanediol di(p-methylbenzoate), and 2-methyl-1,3-pentanediol di(p-tert-butylbenzoate)

Acceptable anhydrous magnesium dihalides forming the support of the solid Ziegler-Natta type catalyst component (a) are the magnesium dihalides in active form that are well known in the art. Such magnesium dihalides may be preactivated, may be activated in situ during the titanation, may be formed in-situ from a magnesium compound, which is capable of forming magnesium dihalide when treated with a suitable halogen-containing transition metal compound, and then activated. Preferred magnesium dihalides are magnesium dichloride and magnesium dibromide. The water content of the dihalides is generally less than 1% by weight.

The solid Ziegler-Natta type catalyst component (a) may be made by various methods. One such method consists of co-grinding the magnesium dihalide and the internal electron donor compound until the product shows a surface area higher than 20 m²/g and thereafter reacting the ground product with the Ti compound. Other methods of preparing solid Ziegler-Natta type catalyst component (a) are disclosed in U.S. Pat. Nos. 4,220,554; 4,294,721; 4,315,835; 4,330,649; 4,439,540; 4,816,433; and 4,978,648. These methods are incorporated herein by reference.

In a typical modified solid Ziegler-Natta type catalyst component (a), the molar ratio between the magnesium dihalide and the halogenated titanium compound is preferably between 1 and 500, the molar ratio between said halogenated titanium compound and the internal electron donor is preferably between 0.1 and 50, and the molar ratio between said internal electron donor and carbonate compound is preferably between 0.1 and 100.

Preferred co-catalyst component (b) includes aluminum alkyl compounds. Acceptable aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component (b) include compounds containing two or more aluminum atoms linked to each other through hetero-atoms, such as:

(C₂H₅)₂Al—O—Al(C₂H₅)₂

(C₂H₅)₂Al—N(C₆H₅)—Al(C₂H₅)₂; and

(C₂H₅)₂Al—O—SO₂—O—Al(C₂H₅)₂.

Acceptable external electron donor component (c) is organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. Preferred component (c) is selected from organosilicon compounds containing Si—O—C and/or Si—N—C bonds. Special examples of such organosilicon compounds are trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro[4.4]nonane, and bis(perhydroisoquinolino)dimethoxysilane. Mixtures of organic electron donors may also be used. Furthermore, the oxalic acid diamides of the present invention may also be employed as an external electronic donor.

The olefin polymerization processes that may be used in accordance with the present invention are not generally limited. For example, the catalyst components (a), (b) and (c), when employed, may be added to the polymerization reactor simultaneously or sequentially. It is preferred to mix components (b) and (c) first and then contact the resultant mixture with component (a) prior to the polymerization.

The olefin monomer may be added prior to, with, or after the addition of the Ziegler-Natta type catalyst system to the polymerization reactor. It is preferred to add the olefin monomer after the addition of the Ziegler-Natta type catalyst system. The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta type catalyst systems of the present invention may be pre-contacted with small quantities of olefin monomer, well known in the art as prepolymerization, in a hydrocarbon solvent at a temperature of 60° C. or lower for a time sufficient to produce a quantity of polymer from 0.5 to 3 times the weight of the catalyst. If such a prepolymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homopolymerization and copolymerization of alpha olefins. Suitable a-olefins that may be used in a polymerization process in accordance with the present invention include olefins of the general formula CH₂=CHR, where R is H or C₁₋₁₀ straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used.

The following analytical methods are used to characterize the polymer.

Heptane Insolubles (% HI): The weight percent (wt %) of residuals of polypropylene sample after extracted with boiling heptane for 8 hours.

Melt Flow rate (MI): ASTM D-1238, determined at 230° C. under the load of 2.16 kg.

Tₘ: ASTM D-3417, determined by DSC (Manufacturer: TA Instrument, Inc; Model: DSC Q1000).

Determination of Isotactic Pentads Content: Place 400 mg of polymer sample into 10 mm NMR tube. 1.7 g TCE-d2 and 1.7 g o-DCB were added into the tube. ¹³C NMR spectra were acquired on a Bruker AVANCE 400 NMR (100.61 MHz, 90° pulse, 12 s delay between pulse). About 5000 transients were stored for each spectrum; mmmm pentad peak (21.09 ppm) was used as reference. The microstructure analysis was carried out as described in literature (Macromolecules, 1994, 27, 4521-4524, by V. Busico, et al.).

Molecular weight (Mn and Mw): The weight average molecular weight (Mw), number average molecular weight (Mn), and molecular weight distribution (Mw/Mn) of polymers were obtained by gel permeation chromatography on Water 2000GPCV system using Polymer Labs Plgel 10 um MIXED-B LS 300×7.5 mm columns and 1,2,4-trichlorobenzene (TCB) as mobile phase. The mobile phase was set at 0.9 ml/min, and temperature was set at 145° C. Polymer samples were heated at 150° C. for two hours. Injection volume was 200 microliters. External standard calibration of polystyrene standards was used to calculate the molecular weight.

Magnesium ethoxide (98%), anhydrous toluene (99.8%), TiCl₄ (99.9%), anhydrous n-heptane (99%), diisobutyl phthalate (99%), cyclohexyl(dimethoxy)methylsilane (C-donor, ≥99%) and triethylaluminum (93%) were all purchased from Sigma-Aldrich Co. of Milwaukee, Wis., USA.

Diisopropyldimethoxysilane (P-donor) and dicyclopentyldimethoxysilane (D-donor) were purchased from Gelest, Inc. of Morrisville, Pa., USA.

Unless otherwise indicated, all reactions were conducted under an inert atmosphere.

### Example 1

### (A) The Preparation of a Solid Catalyst Component

To a three-neck 250 ml flask equipped with fritted filter disc, which is thoroughly purged with anhydrous nitrogen, 7.5 g of magnesium ethoxide, and 80 ml of anhydrous toluene was introduced to form a suspension. 20 ml of TiCl4 was added through a stainless steel cannula. The temperature of the mixture was gradually raised to 90° C., and 8.0 mmol of diisobutylphthalate and 4.0 mmol of diethylcarbonate were charged. The temperature of the mixture was increased to 110° C., and maintained for 2 hours with stirring. The resulting solid was filtered and washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was filtered and residual solid was washed with heptane 7 times at 70° C. The final catalyst was collected and dried under vacuum to obtain a solid catalyst component (A1).

### (B) Propylene Slurry Polymerization

Propylene polymerization was conducted in a bench scale 2-liter reactor per the following procedure. The reactor was first preheated to at least 100° C. with a nitrogen purge to remove residual moisture and oxygen. The reactor was thereafter cooled to 50° C. Under nitrogen, 1 liter dry heptane was introduced into the reactor. When reactor temperature was about 50° C., 4.3 ml of triethylaluminum (0.58M, in hexanes), 0.8-1.6 m1 of dicyclopentyl(dimethoxy)silane (D-donor) (0.5 M in heptane), and then 30 mg of the solid catalyst component (A1) prepared above were added to the reactor. The temperature of the reactor was heated to 50° C. and 8 psi hydrogen in a 150 ml vessel was flushed into the reactor with propylene.

The reactor temperature was then raised to 70° C. The total reactor pressure was raised to and controlled at 90 psig by continually introducing propylene into the reactor and the polymerization was allowed to proceed for 1 hour. After polymerization, the reactor was vented to reduce the pressure to 0 psig and the reactor temperature was cooled to 50° C.

The reactor was then opened. 500 ml methanol was added to the reactor and the resulting mixture was stirred for 5 minutes then filtered to obtain the polymer product. The obtained polymer was vacuum dried at 80° C. for 6 hours. The polymer was evaluated for melt flow rate (MFR), and heptane insoluble (% HI). The activity of catalyst (AC) was also measured. The results are summarized in Tables 1 and 2.

### (C) Propylene Block Co-Polymerization

Propylene bulk polymerization was conducted in a 2 liter autoclave reactor as described above. The reactor was first preheated to at least 100° C. with a nitrogen purge to remove residual moisture and oxygen. The reactor was thereafter cooled to 20° C. Under nitrogen, 6 mg of solid catalyst component (A1), 5 ml of triethylaluminum (0.58M, in hexanes), 0.25 mmol of diisopropyldimethoxysilane were charged. After addition of hydrogen as listed in Table 1 and 1.2 liter of liquefied propylene, the mixture was stirred for 5 min at 20° C., and then the temperature was raised to 70° C. within 5 min. The polymerization was conducted for 45 min at 70° C. After completion of homo-polymerization, propylene was discharged as reactor temperature lowered to 40° C. Then, ethylene and propylene, were sequentially fed into the autoclave in a molar ratio of 1.0/1.0 and co-polymerization was carried out for 50 min at 70° C. to obtain the propylene block co-polymerization. The results are summarized in Table 3.

### Example 2

A solid catalyst component (A2) was prepared in the same manner as in Example 1, except that 8.0 mmol of diethylcarbonate and 5.3 mmol of 2-isopropyl-2-(1-methylbutyl)-1,3-dimethoxy propane was used instead. Propylene polymerization and propylene block copolymerization were carried out in the same manner as described in Example 1, except that solid catalyst component (A2) was charged instead of solid catalyst component (A1). The results are summarized in Tables 1, 2 and 3.

### Example 3

A solid catalyst component (A3) was prepared in the same manner as in Example 1, except that 6.0 mmol of diethylcarbonate and 8.0 mmol of 2-isopropyl-2-(1-methylbutyl)-1,3-dimethoxy propane was used instead. Propylene polymerization and propylene block co-polymerization were carried out in the same manner as described in Example 1, except that solid catalyst component (A3) was charged instead of solid catalyst component (A1). The results are summarized in Tables 1 and 2.

### Example 4

A solid catalyst component (A4) was prepared in the same manner as in Example 1, except that 8.0 mmol of diisobutylphthalate and 5.3 mmol of 2-isopropyl-2-(1-methylbutyl)-1,3-dimethoxy propane with 5.3 mmol of diethylcarbonate was used instead. Propylene polymerization and propylene block co-polymerization were carried out in the same manner as described in Example 1, except that solid catalyst component (A4) was charged instead of solid catalyst component (A1). The results are summarized in Tables 1, 2, and 3.

### Comparative Example 1

### (A) The Preparation of a Solid Catalyst Component (C1)

To a three-neck 250 ml flask equipped with fritted filter disc, which is thoroughly purged with anhydrous nitrogen, 7.5 g of magnesium ethoxide, and 80 ml of anhydrous toluene was introduced to form a suspension. 20 ml of TiCl4 was added through a stainless steel cannula. The temperature of the mixture was gradually raised to 90° C., and 8.0 mmol of diisobuylphthalate was charged. The temperature of the mixture was increased to 110° C., and maintained for 2 hours with stirring. The resulting solid was filtered and washed twice with 100 ml of anhydrous toluene at 90° C., and then 80 ml of fresh anhydrous toluene and 20 ml TiC14 was added to the filtered solid. Temperature of the mixture was heated to 110° C., and stirred for 2 hours. The solid was filtered and residual solid was washed with heptane 7 times at 70° C. The final catalyst was collected and dried under vacuum to obtain a solid catalyst component (C1).

### Comparative Example 2

### (A) The Preparation of a Solid Catalyst Component (C2)

To a three-neck 250 ml flask equipped with fritted filter disc, which is thoroughly purged with anhydrous nitrogen, 7.5 g of magnesium ethoxide, and 80 ml of anhydrous toluene was introduced to form a suspension. 20 ml of TiCl4 was added through a stainless steel cannula. The temperature of the mixture was gradually raised to 90° C., and 8.0 mmol of 2-isopropyl-2-(1-methylbutyl)-1,3-dimethoxy propane was charged. The temperature of the mixture was increased to 110° C., and maintained for 2 hours with stirring. The resulting solid was filtered and washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was filtered and residual solid was washed with heptane 7 times at 70° C. The final catalyst was collected and dried under vacuum to obtain a solid catalyst component (C2).

### Comparative Example 3

### (A) The Preparation of a Solid Catalyst Component (C3)

A solid catalyst component (C3) was prepared in the same manner as in Example 1, except that 8.0 mmol of diisobutylphthalate and 8.0 mmol of 2-isopropyl-2-(1-methylbutyl)-1,3-dimethoxy propane was used instead.

### (B) Propylene Slurry Polymerization

Propylene polymerization was carried out in the same manner as described in Example 1, except that the solid catalyst component (C1, C2 or C3) was charged instead of solid catalyst component (A1). The results are summarized in Tables 1 and 2.

### (C) Propylene Block Co-Polymerization

Propylene block co-polymerization was conducted in the same manner as Example 1, except that solid catalyst component (C1, C2 or C3) was charged instead of solid catalyst component (A1). The results are summarized in Table 3

TABLE 1

| | | Internal |
|---|---|---|
| | Catalyst | Donor |
| Example | Component | (mmol) |
| Ex. 1 | A1 | DiBP* (8.0) + diethylcarbonate (4.0) |
| Ex. 2 | A2 | 1,3-diether** (5.3) + diethylcarbonate (8.0) |
| Ex. 3 | A3 | 1,3-diether** (8.0) + diethylcarbonate (6.0) |
| Ex. 4 | A4 | DiBP*(8.0) + 1,3-diether** (5.3) + |
| | | diethylcarbonate (5.3) |
| Comp. | C1 | DiBP* (8.0) |
| Ex 1 | | |
| Comp. | C2 | 1,3-diether** (8.0) |
| Ex 2 | | |
| Comp | C3 | DiBP *(8.0) + 1,3-diether** (8.0) |
| Ex 2 | | |

*DIBP = Diisobutylphthalate
**1,3-diether = 2-isopropyl-2-(1-methylbutyl)-1,3-dimethoxy propane

TABLE 2

| | | Ext. | | Activity | | MFR |
|---|---|---|---|---|---|---|
| | | Donor | H2 | (g/g | HI | (g/10 |
| Example | Catalyst | (mmol) | (mmol) | cat.) | (%) | min) |
| Ex. 1 | A1 | P(0.4) | 13.6 | 5817 | 99.1 | 7.5 |
| | | P(0.4) | 22.7 | 5097 | 98.8 | 16.8 |
| Comparative | C1 | P(0.4) | 9.1 | 4433 | 98.6 | 6.0 |
| Ex 1 | | P(0.4) | 13.6 | 4410 | 98.2 | 11.2 |
| Ex 2 | A2 | P(0.4) | 9.1 | 6680 | 98.1 | 15.3 |
| | | P(0.4) | 18.2 | 6067 | 97.7 | 53.5 |
| Ex. 3 | A3 | P(0.4) | 13.6 | 7273 | 98.0 | 42.1 |
| Comparative | C2 | P(0.4) | 9.1 | 6826 | 98.2 | 13.8 |
| Ex 2 | | | | | | |
| Ex. 4 | A4 | P(0.4) | 9.1 | 8953 | 99.1 | 10.8 |
| | | P(0.4) | 18.2 | 8653 | 98.7 | 30.2 |
| Comparative | C3 | P(0.4) | 13.6 | 5546 | 98.9 | 22.8 |
| Ex 3 | | | | | | |

TABLE 3
Propylene Block Co-Polymerization Summary

| | | Ext. | | ICP | | | | |
|---|---|---|---|---|---|---|---|---|
| | | Donor | H2 | Activity | | | | |
| Example | Catalyst | (mmol) | (mmol) | (g/g cat.) | EPR(%) | MFR | C2% | RCC2(%) |
| Ex. 1 | A1 | P(0.4) | 121 | 35,557 | 25.6 | 2.9 | 13.4 | 52.3 |
| Comparative Ex 1 | C1 | P(0.4) | 121 | 33,457 | 24.0 | 3.0 | 12.2 | 50.8 |
| Ex 2 | A2 | P(0.4) | 121 | 41,000 | 21.8 | 8.5 | 11.4 | 51.4 |
| Ex. 3 | A3 | P(0.4) | 121 | 35071 | 21.0 | 5.6 | 11.0 | 51.0 |
| Comparative Ex 2 | C2 | P(0.4) | 121 | 36,600 | 13.7 | 13.9 | 6.5 | 46.9 |
| EX. 4 | A4 | P(0.4) | 121 | 33,528 | 29.3 | 3.3 | 14.7 | 51.3 |
| | | P(0.4) | 182 | 32,657 | 27.6 | 6.9 | 13.5 | 49.0 |
| Comparative Ex 3 | C3 | P(0.4) | 121 | 36,685 | 19.5 | 13.3 | 9.7 | 49.8 |

As shown from the above results, the employment of carbonate compounds as an element of catalysts (Ex. 1) composition in combination with internal donors such as DiBP produce polypropylene with an isotacticity (HI %) equal to 99.1%, which is much higher than the comparative catalyst components of Comparative Ex. 1 (HI %=98.6%),) which does not contain carbonate compounds in its solid catalyst composition.

Also, as shown in the Examples 2 and 3, the employment of carbonate compounds in combination with internal donors of 1,3-diether, produce polypropylene with a good isotacticity (HI %=98.0-98.1%), with much higher co-polymerization capability providing much higher rubber content (21.0-21.8%) than the comparative catalyst components (13.7%), employing 1,3-diether as internal donor without carbonate compounds in its solid catalyst composition. In particular, catalyst components A4 in Ex. 4, where diethylcarbonate was used in conjunction with both 1,3-diether and diisobutylphthalate donor as internal donor, show much higher co-polymerization capability to produce high rubber content (27.6-29.3%) than the Comparative Ex. 3 catalyst (19.5%) having the same internal donors but without diethylcarbonate, while providing high isotacticity (HI=98.7-99.1%)

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A solid catalyst component for the polymerization or co-polymerization of alpha-olefins comprising: titanium, magnesium, halogen, at least one internal electron donor, and a carbonate compound selected from the compound represented by Formula I: 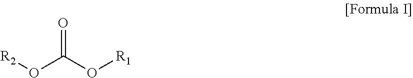
wherein R₁ and R₂ are independently selected from hydrogen, an aliphatic hydrocarbon group having 1 to 20 carbon atoms, an alicyclic hydrocarbon group having 3-20 carbon atoms, or an aromatic hydrocarbon group having 6-20 carbon atoms.

2. The solid catalyst component of claim 1, wherein Ri and R2 are linked to form one or more saturated or unsaturated monocyclic or polycyclic rings.

3. The solid catalyst component of claim 1, wherein the carbonate compound is a dialkylcarbonate.

4. The solid catalyst component of claim 1, wherein the carbonate compound is diethylcarbonate.

5. The solid catalyst component of claim 1, wherein the carbonate compound is selected from diethylcarbonate, dimethylcarbonate, diisopropylcarbonate, dipropylcarbonate, dibutylcarbonate, ditertbutylcarbonate, dicyclopentylcarbonate, dicyclohexylcarbonate, diphenylcarbonate, dibenzylcarbonate propylene carbonate, ethylene carbonate, or trimethylene carbonate.

6. The solid catalyst component of claim 1, wherein the at least one internal electron donor comprises a first internal electron donor and a second internal electron donor.

7. The solid catalyst component of claim 6, wherein the first internal electron donor is a phthalate compound, and wherein the second internal electron donor is a 1,3 diether compound.

8. The solid catalyst component of claim 1, wherein the at least one internal electron donor comprises a 1,3 diether compound.

9. The solid catalyst component of claim 1, wherein the at least one internal electron donor comprises an ester of phthalic acid.

10. The solid catalyst component of claim 1, wherein the at least one internal donor comprises a malonate compound.

11. The solid catalyst component of claim 1, wherein the at least one internal donor comprises an ester of succinic acid.

12. The solid catalyst component of claim 1, wherein the at least one internal donor comprises an ester of a diol compound.

13. A catalyst system for the polymerization or co-polymerization of alpha-olefins comprising:
a) a solid catalyst component of claim 1; and
b) an organoaluminum co-catalyst component.

14. The catalyst system of claim 13, further comprising one or more external electron donor components.
